(19) United States
(12) Patent Application Publication
(10) Pub. No.: US 2012/0051700 A1
(43) Pub. Date: Mar. 1, 2012

(54) Optical communication device, method for manufacturing the same, and optical fiber connector

(75) Inventors: Kazuhiro Terada, Kiyosu-shi (JP); Kenji Haga, Kiyosu-shi (JP); Yukitoshi Inui, Kiyosu-shi (JP); Naoyuki Okita, Kiyosu-shi (JP); Akiko Okita, Kiyosu-shi (JP)

(73) Assignee: TOYODA GOSEI CO., LTD., Kiyosu-shi (JP)

(21) Appl. No.: 13/137,623

(22) Filed: Aug. 30, 2011

(30) Foreign Application Priority Data
Sep. 1, 2010 (JP) 2010-196220

(51) Int. Cl. G02B 6/36; B23P 17/04

(52) U.S. Cl. 385/92; 29/428

(57) ABSTRACT

An optical communication device, comprises an optical fiber connector including a connector housing and an optical multiplexer/demultiplexer, the optical multiplexer/demultiplexer having a self-written optical waveguide core that is branched through an optical filter, connected to a leading end of an optical fiber, the leading end of the optical fiber and the multiplexer/demultiplexer being integrally housed in the connector housing; and a cap housing which houses light receiving/emitting elements provided with leads exposed from the cap housing, into which the optical fiber connector is to be removably inserted such that light receiving/emitting sides of the light receiving/emitting elements are disposed so as to oppose respective branched ends of the self-written waveguide core.

### BACKGROUND OF THE INVENTION

1. Field of the Invention

The present invention relates to an optical communication device made up of an optical multiplexer/demultiplexer connected to an optical fiber and light receiving/emitting elements connected to branched ends of the optical multiplexer/demultiplexer. The present invention also relates to an optical fiber connector having a novel configuration.

2. Description of the Related Art

The present patent applicants, and others, have recently developed a plurality of self-written optical waveguide techniques for forming an optical waveguide by utilization of a photo-curable resin. An optical device, like an optical multiplexer/demultiplexer formed from a self-written optical waveguide that is bifurcated and formed by means of an optical filter, has been developed.

Patent Documents 1 and 2 show an optical communication device configured in such a way that an optical multiplexer/demultiplexer formed from a self-written optical waveguide and a light receiving/emitting element are housed in a monolithic enclosure and that an optical fiber connector is inserted into the housing, to thus be connected to the optical multiplexer/demultiplexer.
Patent Document 1: JP-A-2001-242354
Patent Document 2: JP-A-2010-32582

A heat-resistant temperature of a self-written optical waveguide is about 120° C., and a light receiving/emitting element cannot be mounted on a substrate by means of a reflow process. Therefore, when the light receiving/emitting element is mounted on a related art substrate, a lead terminal of the light receiving/emitting element is manually soldered to the substrate by way of a through hole formed in the substrate, which involves consumption of much effort and time, to thus raise a problem of deterioration of mass-productivity.

Accordingly, an objective of the invention is to implement an optical communication device exhibiting superior mass-productivity and a method for manufacturing the same. Another objective is to implement an optical fiber connector capable of configuring an optical communication device exhibiting superior mass-productivity.

A first aspect of the invention is an optical communication device comprising an optical fiber connector including a connector housing and an optical multiplexer/demultiplexer, the optical multiplexer/demultiplexer having a self-written optical waveguide core that is branched through an optical filter, connected to a leading end of an optical fiber, the leading end of the optical fiber and the multiplexer/demultiplexer being integrally housed in the connector housing; and a cap housing which houses light receiving/emitting elements provided with leads exposed from the cap housing, into which the optical fiber connector is to be removably inserted such that light receiving/emitting sides of the light receiving/emitting elements are disposed so as to oppose respective branched ends of the self-written waveguide core.

The optical multiplexer/demultiplexer may assume an arbitrary structure, so long as the structure includes one or a plurality of optical filters and a self-written optical waveguide core branched by an optical filter. In addition to a structure including bifurcating a self-written optical waveguide core by one optical filter, a structure including dividing a self-written optical waveguide core into three or more branches by means of two or more optical filters can also be adopted. The self-written optical waveguide core is an axial optical waveguide core formed by use of the self-written optical waveguide technique and is a hardened substance consisting of a photo-curable resin. From the viewpoint of loss reduction or securement of physical strength, it is preferable that the self-written optical waveguide core should be covered with an optical waveguide clad. The optical waveguide clad can also be formed by use of a photo-curable resin. The optical filter is also a half mirror, a wavelength selection filter, a polarizing filter, and the like.

It is desirable that branched end faces of the self-written optical waveguide core should be provided with a protective plate for preventing an increase in light loss, which would otherwise be caused when damage is inflicted on the end faces as a result of removal attachment of the optical fiber connector. The protective plate is; for instance, a glass material.

In the present invention, the light receiving/emitting element exemplifies any of a light emitting element, a light emitting-and-receiving element, and both of them. The light emitting element is; for instance, a semiconductor laser or an LED. The light receiving element is a photodiode, or the like.

The optical multiplexer/demultiplexer can also be placed in such a way that the divided self-written optical waveguide cores form a plane and that the thus-formed plane becomes perpendicular to a surface of the substrate on which the light receiving/emitting element is mounted. A degree of positional freedom of leads of the light receiving/emitting elements is enhanced, so that mounting the optical multiplexer/demultiplexer to the substrate becomes easier.

A second aspect of the invention is the optical communication device wherein a protective plate for protecting the connector housing is provided in a neighborhood of the branched ends of the self-written waveguide core that is outside the connector hosing of the optical fiber connector.

A third aspect of the invention is a method for manufacturing an optical communication device, comprising connecting, to a leading end of an optical fiber, an optical multiplexer/demultiplexer having a self-written optical waveguide core that is branched through an optical filter, and integrally housing the leading end of the optical fiber and the optical multiplexer/demultiplexer into a connector housing, so as to form an optical fiber connector; placing light receiving/emitting elements in a cap housing into which the optical fiber connector is to be inserted such that light receiving/emitting sides oppose respective branched ends of the self-written waveguide core, and forming the cap housing such that leads of the light receiving/emitting elements become exposed from the cap housing; implementing the cap housing on a substrate and mounting the light receiving/emitting elements to the substrate by reflow; an subsequently inserting the optical fiber connector into the cap housing.

The optical fiber connector can be formed before formation of a cap housing, after the light receiving/emitting element is mounted on the substrate by means of a reflow process, or in parallel with processing pertaining to these processes.

A fourth aspect of the invention is an optical fiber connector characterized in that an optical multiplexer/demultiplexer which has a self-written optical waveguide core divided into a plurality of branches by way of an optical filter is connected to a leading end of an optical fiber and that the leading end of the optical fiber and the optical multiplexer/demultiplexer are integrally housed in a connector housing.

A fifth aspect of the invention is based on the fourth invention and characterized in that a protective plate for protecting the connector housing is provided in a neighborhood of branched ends of the self-written waveguide core that is outside the connector housing of the optical fiber connector.

In the optical communication device of the first invention, the optical multiplexer/demultiplexer is integrated with the leading end of the optical fiber by means of the connector housing. The optical multiplexer/demultiplexer is separated from the cap housing having the light receiving/emitting element. Therefore, only the cap housing not having the optical multiplexer/demultiplexer is caused to pass through a reflow furnace, whereby the light emitting/receiving element can be mounted on the substrate without exposing to high temperatures the optical multiplexer/demultiplexer formed from the self-written optical waveguide core. Therefore, the optical communication device of the present invention is superior in mass-productivity.

The protective film is provided as described in connection with the second invention, thereby preventing infliction of damage to the connector housing in the neighborhood of the branched ends of the self-written waveguide core during removal attachment of the optical fiber connector. Thus, an increase in light loss can be controlled.

Under the method for manufacturing an optical communication device described in connection with a third invention, the light receiving/emitting element can be mounted on the substrate by means of the reflow process. Therefore, the method exhibits superior mass-productivity.

The optical fiber connectors of the fourth and fifth inventions assume a novel configuration in which the leading end of the optical fiber and the optical multiplexer/demultiplexer are integrally housed in the connector housing. An optical communication device having such an optical fiber connector exhibits superior mass-productivity.

### BRIEF DESCRIPTION OF THE DRAWINGS

FIGS. 1A and 1B are drawings showing a configuration of an optical communication device of a first embodiment;

FIGS. 2A, 2B, and 2C are drawings showing a configuration of an optical fiber connector 1;

FIGS. 3A, 3B, and 3C are drawings showing a configuration of a cap housing 2;

FIGS. 4A, 4B, and 4C are drawings showing a top view, a front view, and a bottom view of the optical fiber connector 1;

FIGS. 5A and 5B are cross sectional views of the optical fiber connector 1;

FIGS. 6A, 6B, 6C, 6D, and 6E are drawings showing a front view, a top view, a bottom view, a left-side view, and a right-side view of the cap housing 2; and

FIGS. 7A and 7B are cross sectional views of the cap housing 2.

### DESCRIPTION OF THE PREFERRED EMBODIMENTS

Although a specific embodiment of the present invention is hereunder described by reference to the drawings, the present invention is not limited to the embodiment.

### First Embodiment

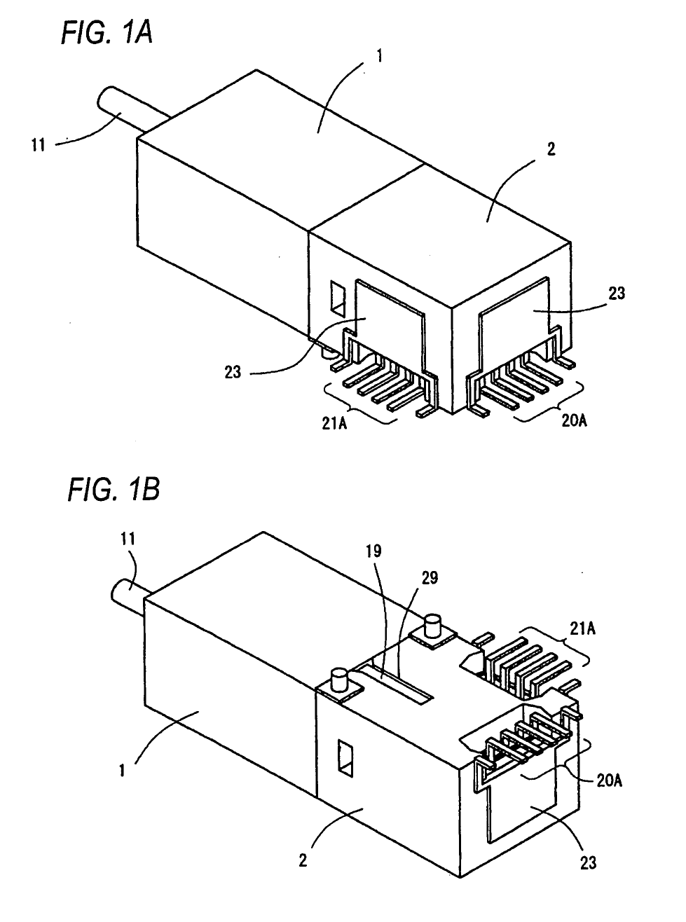

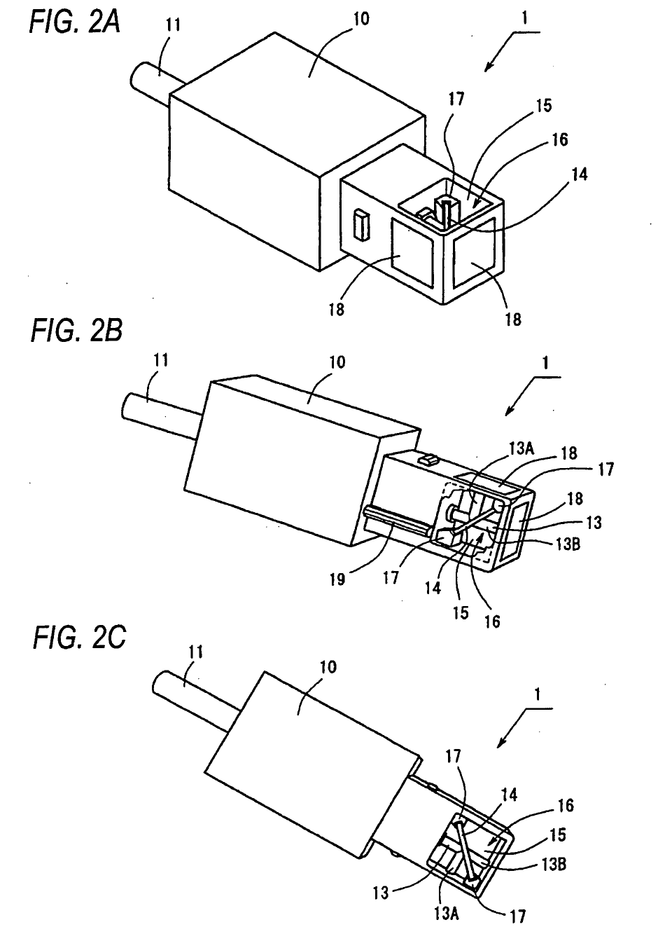

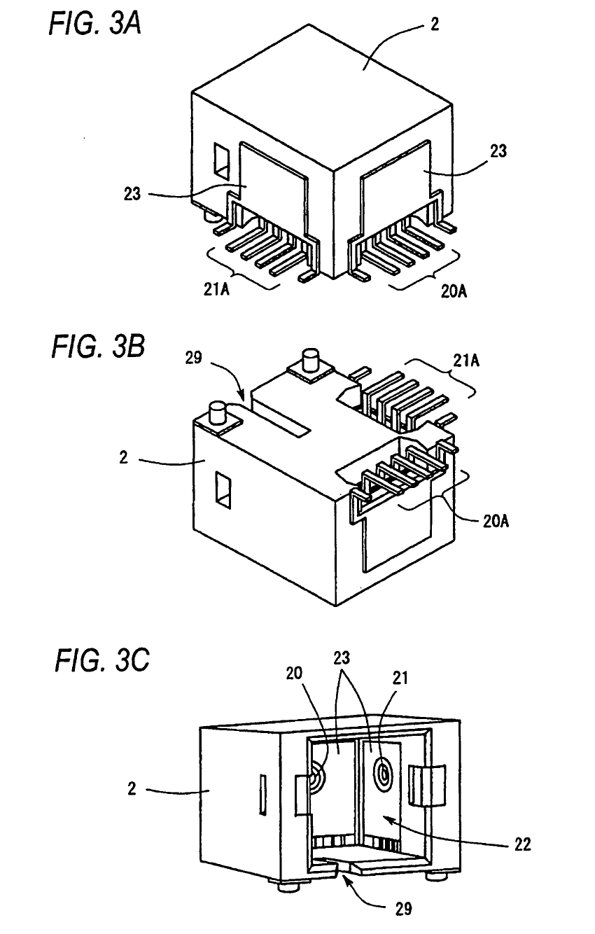

FIGS. 1A and 1B are views showing a configuration of an optical communication device of a first embodiment. FIG. 1A is a drawing of the optical communication device when viewed from diagonally above, and FIG. 1B is a drawing of the same when viewed from diagonally below. The optical communication device is made up of an optical fiber connector 1 and a cap housing 2 into which the optical fiber connector 1 is inserted. The optical fiber connector 1 is removable from the cap housing 2. FIGS. 2A, 2B, 2C, 3A, 3B, and 3C are drawings showing a configuration of the optical fiber connector 1 and a configuration of the cap housing 2 when the optical fiber connector 1 is removed from the cap housing 2. FIG. 2A is a drawing of the optical communication device when viewed obliquely from above; FIG. 2B is a drawing of the same when viewed from below; and FIG. 2C is a drawing of the same when viewed from above. In FIGS. 3A, 3B, and 3C, FIG. 3A is a drawing of the cap housing when viewed from obliquely above; FIG. 3B is a drawing of the cap housing when viewed from obliquely below; and FIG. 3C is a drawing of the cap housing when viewed from a side into which the optical fiber connector 1 is to be inserted.

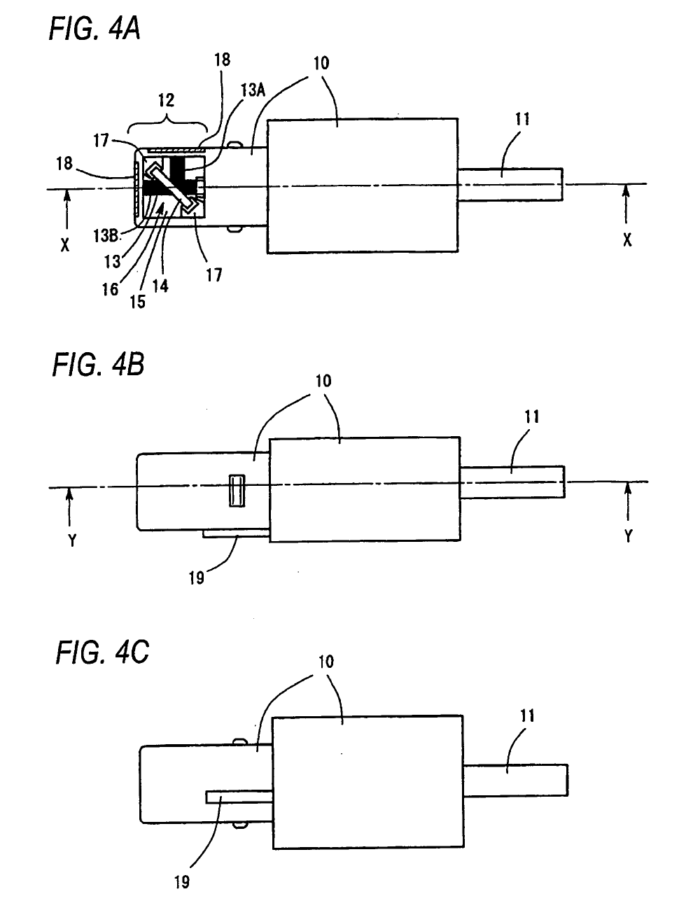

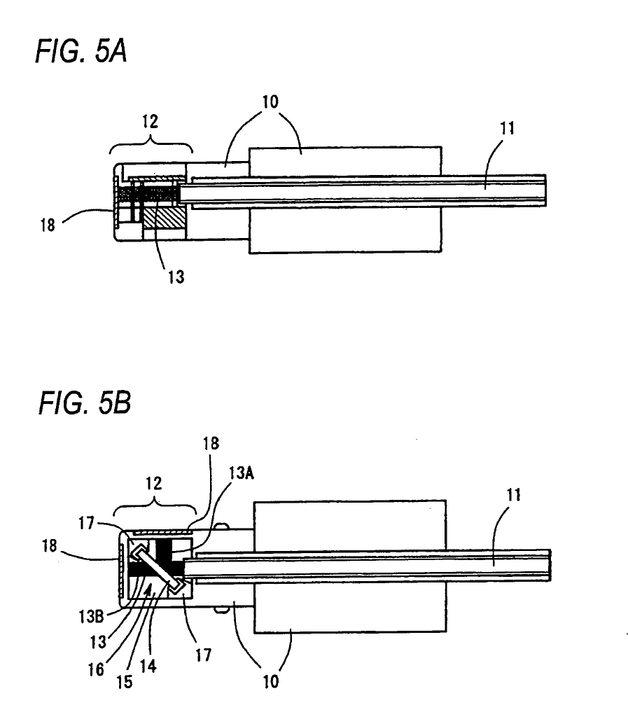

FIGS. 4A to 4C show a top view, a front view, and a bottom view of the optical fiber connector 1. FIG. 5A is a cross sectional view of the connector taken along line X-X shown in FIG. 4A, and FIG. 5B is a cross sectional view of the same taken along line Y-Y shown in FIG. 4B. As shown in FIGS. 2A, 2B, 2C, 4A, 4B, 4C, 5A, and 5B, the optical fiber connector 1 includes a connector housing 10, a leading end of an optical fiber 11 housed in the connector housing 10, and an optical multiplexer/demultiplexer 12.

The optical multiplexer/demultiplexer 12 is made up of an optical waveguide core 13, an optical filter 14, and an optical waveguide clad 15 covering the optical waveguide core 13. The optical multiplexer/demultiplexer has a structure in which the optical waveguide core 13 connected to the leading end of the optical fiber 11 is bifurcated into two optical waveguide cores 13A and 13B by means of the optical filter 14. The optical waveguide core 13B is bifurcated to thus lie in the extension of an axis of the optical fiber 11, and the optical waveguide core 13A is bifurcated into a direction perpendicular to the axis of the optical fiber 11. A recess 16 is provided on a side of the connector housing 1 facing the leading end of the optical fiber 11, and the optical waveguide core 13 and the optical filter 14 are housed in the recess 16. The optical filter 14 is fastened by means of a holding fixture 17. The optical waveguide clad 15 is provided so as to fill the recess 16, whereby the optical waveguide core 13 is covered with the optical waveguide clad 15. The optical waveguide core 13 and the optical waveguide clad 15 are hardened materials consisting of a photo-curable resin and are formed by means of the well-known self-written optical waveguide technique. Heat resistance of the hardened substance of the photo-curable resin is about 120° C. Moreover, the optical filter 14 is a half mirror, a wavelength selection filter, a polarizing filter, or the like.

A glass plate 18 is embedded in an area that is outside of the connector housing 10 and that opposes end faces of the optical waveguide cores 13A and 13B. The glass plate 18 prevents occurrence of an increase in light loss, which would otherwise be caused as a result of damage being inflicted on an exterior of the connector housing located in the vicinity of the end faces of the optical waveguide cores 13A and 13B on the occasion of insertion or removal of the optical fiber connector 1 into or from the cap housing 2.

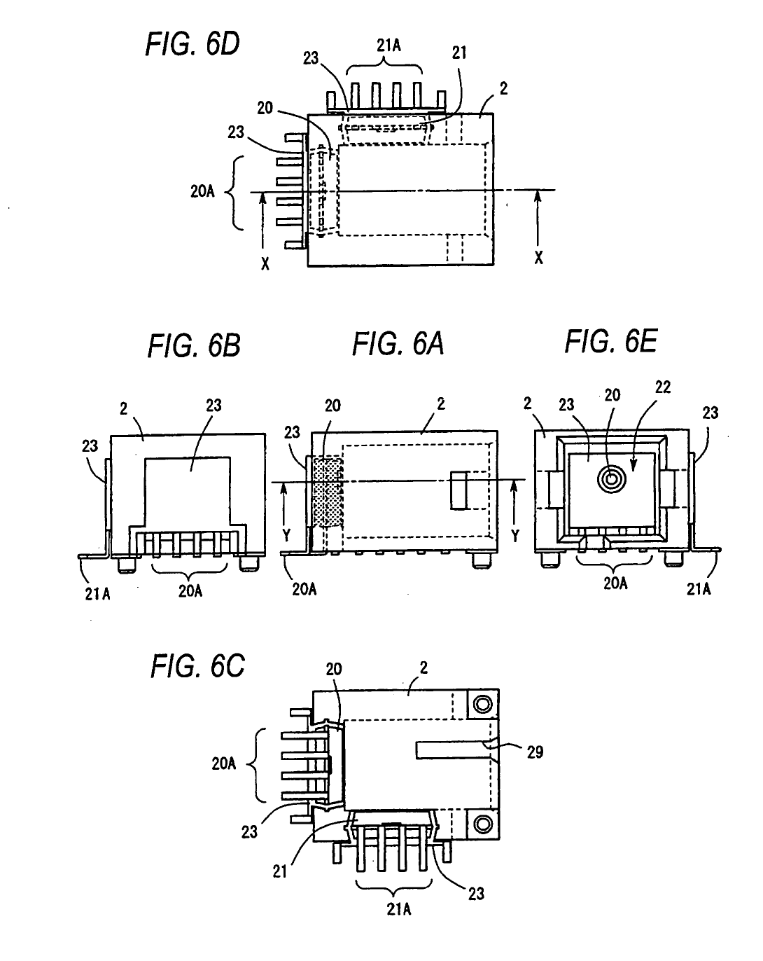

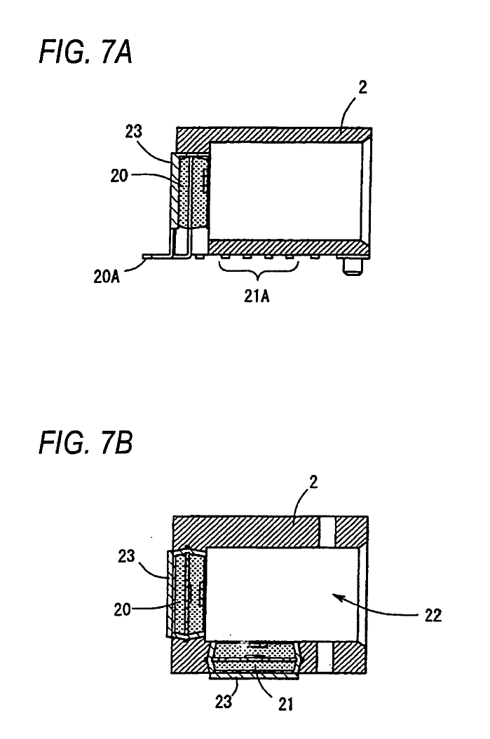

FIGS. 6A to 6E show a front view, a top view, a bottom view, a left-side view, and a right-side view of the cap housing 2. FIG. 7A is a cross sectional view taken along line X-X shown in FIG. 6B, and FIG. 7B is a cross sectional view taken along line Y-Y shown in FIG. 6A. As shown in FIGS. 3A, 3B, 3C, 6A, 6B, 6C, 6D, 6E, 7A, and 7B, the cap housing 2 is a rectangular parallelepiped made of an epoxy resin and has a recess 22 into which the optical fiber connector 1 is removably inserted. Light receiving/emitting elements 20 and 21 are housed in the cap housing 2. The light receiving/emitting elements 20 and 21 correspond to a light emitting element like a light emitting diode and a semiconductor laser, a light receiving element like a photodiode, or both a light emitting element and a light receiving element. For instance, one of the light receiving/emitting elements 20 and 21 is embodied by an LED, and the other element is embodied by a photodiode, whereby the optical communication device of the first embodiment can be caused to act as an optical transceiver. The light receiving/emitting elements 20 and 21 are packaged in a metal shield 23 in order to block noise.

The light receiving/emitting elements 20 and 21 are disposed in such a way that a light receiving/emitting side of the cap housing 2 is directed toward an interior of the recess 22, and light receiving/emitting surfaces of the light receiving/emitting elements are perpendicular to each other. In a state in which the optical fiber connector 1 is inserted into the cap housing 2, the light receiving/emitting elements 20 and 21 are arranged in such a way that an end face of the optical waveguide core 13A and the light receiving/emitting side of the light receiving/emitting element 21 oppose each other and that an end face of the optical waveguide core 13B and the light receiving/emitting side of the light receiving/emitting element 20 oppose each other. By means of such an arrangement, there is achieved a structure in which the optical waveguide core 13A and the light receiving/emitting element 21 are optically connected together and in which the optical waveguide core 13B and the light receiving/emitting element 20 are optically connected together.

Four leads 20A and 21A of the light receiving/emitting elements 20 and 21 project outside from the respective cap housing 2 and bent so as to become horizontal with respect to a surface of the substrate on which the optical communication device is to be mounted.

A linear projection 19 is provided on a lower portion of the connector housing 1, and a linear recess 29 is provided on a lower portion of the cap housing 2. The recess 29 and the projection 19 are configured so as to mesh each other. This is intended for preventing insertion of an incorrect connector into the cap housing 2.

The cap housing 2 housing the light receiving/emitting elements 20 and 21 is subjected to reflow while the optical fiber connector 1 is removed, so that the light emitting/receiving elements 20 and 21 are mounted to the substrate. The optical fiber connector 1 is subsequently inserted into the cap housing 2, whereby the optical communication device of the first embodiment is manufactured.

Reflow mounting of the light receiving/emitting elements to the substrate is described in more detail. First, solder is printed at predetermined positions on the substrate on which wiring is formed (i.e., locations where the leads 20A and 21A of the light receiving/emitting elements 20 and 21 are connected). Next, the cap housing 2 is implemented on the substrate in such a way that the printed solder overlaps the leads 20A and 21A of the light receiving/emitting elements 20 and 21. The cap housing 2 implemented on the substrate is next subjected to reflow soldering, thereby soldering the wiring on the substrate to the leads 20A and 21A of the light receiving/emitting elements 20 and 21. On this occasion, a material exhibiting heat resistance that is higher than a reflow temperature is used for an epoxy resin that is a material of the cap housing 2 and the light receiving/emitting elements 20 and 21. The light receiving/emitting elements 20 and 21 are implemented on the substrate through foregoing processes.

In the optical communication device of the first embodiment, the optical multiplexer/demultiplexer 12 is housed in the connector housing 10, to thus make up the optical fiber connector 1. The optical multiplexer/demultiplexer is separated from the cap housing 2 that houses the light receiving/emitting elements 20 and 21. Consequently, the leads of the light receiving/emitting elements 20 and 21 can be reflow mounted to the substrate without exposing to high temperatures the optical multiplexer/demultiplexer 12 made up of the optical waveguide core 13 that is a hardened substance of a low heat resistant photo-curable resin and the optical waveguide clad 15. The optical communication device can readily be manufactured by subjecting the light receiving/emitting elements 20 and 21 to reflow mounting and subsequently inserting the optical fiber connector 1 into the cap housing 2. As mentioned above, the light receiving/emitting elements 20 and 21 can be mounted on the substrate by means of reflow, therefore the optical communication device of the first embodiment exhibits superior mass productivity.

In the optical communication device of the first embodiment, the face formed from the bifurcated optical waveguide cores 13A and 13B is horizontal to the substrate to which the optical communication device is to be mounted. However, the optical waveguide core 13A may also be disposed so as to become perpendicular to the substrate. As a result, the leads of the light receiving/emitting elements 20 and 21 can be pulled to a more free location outside the cap housing 2, so that mounting the light receiving/emitting elements 20 and 21 on the substrate become easier.

The optical multiplexer/demultiplexer 12 in the optical communication device of the first embodiment has a structure in which the optical waveguide core is bifurcated by means of the optical filter. However, an optical multiplexer/demultiplexer having another arbitrary structure can also be used. For instance, the optical multiplexer/demultiplexer may also be an optical multiplexer/demultiplexer in which the optical waveguide core is trifurcated by use of two optical filters.

The optical communication device of the present invention can be used for an optical LAN system, like a vehicle-mounted LAN system.

The present patent application is based on Japanese Patent Application (JP-2010-196220) filed on Sep. 1, 2010, the entire subject matter of which is incorporated herein by reference.

What is claimed is:

1. An optical communication device, comprising:
an optical fiber connector including a connector housing and an optical multiplexer/demultiplexer, the optical multiplexer/demultiplexer having a self-written optical waveguide core that is branched through an optical filter, connected to a leading end of an optical fiber, the leading end of the optical fiber and the multiplexer/demultiplexer being integrally housed in the connector housing; and
a cap housing which houses light receiving/emitting elements provided with leads exposed from the cap housing, into which the optical fiber connector is to be removably inserted such that light receiving/emitting sides of the light receiving/emitting elements are disposed so as to oppose respective branched ends of the self-written waveguide core.

2. The optical communication device according to claim 1, wherein a protective plate for protecting the connector housing is provided in a neighborhood of the branched ends of the self-written waveguide core that is outside the connector hosing of the optical fiber connector.

3. A method for manufacturing an optical communication device, comprising;
connecting, to a leading end of an optical fiber, an optical multiplexer/demultiplexer having a self-written optical waveguide core that is branched through an optical filter, and integrally housing the leading end of the optical fiber and the optical multiplexer/demultiplexer into a connector housing, so as to form an optical fiber connector;
placing light receiving/emitting elements in a cap housing into which the optical fiber connector is to be inserted such that light receiving/emitting sides oppose respective branched ends of the self-written waveguide core, and forming the cap housing such that leads of the light receiving/emitting elements become exposed from the cap housing;
implementing the cap housing on a substrate and mounting the light receiving/emitting elements to the substrate by reflow; and
subsequently inserting the optical fiber connector into the cap housing.

4. An optical fiber connector, comprising:
an optical multiplexer/demultiplexer having a self-written optical waveguide core that is branched by an optical filter and connected to a leading end of an optical fiber, wherein the leading end of the optical fiber and the optical multiplexer/demultiplexer are integrally housed in a connector housing.

5. The optical fiber connector according to claim 4, wherein a protective plate for protecting the connector housing is provided in a neighborhood of branched ends of the self-written waveguide core that is outside the connector hosing of the optical fiber connector.
